(19) United States
(12) Patent Application Publication
(10) Pub. No.: US 2008/0009183 A1
(43) Pub. Date: Jan. 10, 2008

(54) HIGH DENSITY MODULE CONNECTOR

(76) Inventor: Ching-Li Wu, Taipei City (TW)

Correspondence Address: SCHMEISER, OLSEN & WATTS, 22 CENTURY HILL DRIVE, SUITE 302, LATHAM, NY, 12110, US

(21) Appl. No.: 11/428,906

(22) Filed: Jul. 6, 2006

(51) Int. Cl. H01R 13/60

(52) U.S. Cl. 439/540.1

(57) ABSTRACT

The present invention discloses a high density module connector that includes a combining base, a plurality of connectors and a packaging module. A high density module connector is used to substitute a circuit board of a traditional patch panel, so as to overcome the shortcoming of replacing the whole circuit board when a certain wire clamp groove on the circuit board fails. If a connector in the high density module connector fails, it is necessary to change the connector only for the patch panel to be operated normally again. The high density module connector can separate the circuits and reduce the interference caused by the densely installed circuits effectively.

### FIELD OF THE INVENTION

The present invention relates to a module connector, and more particularly to a high density module connector used for patch panels.

### BACKGROUND OF THE INVENTION

As science and technology advance, Internet is used more extensively, and network devices have become indispensable equipments for every company. Due to the high demand on the transmission efficiency of network communication systems, not only the requirements for the wiring quality get higher, but the requirements for stability and convenience of network connectors also become stricter.

Referring to FIG. 1 for a traditional wire-bonded patch panel, the traditional patch panel 10 has a plurality of circuit boards 110 disposed therein, such that the network cable can be coupled to a plurality of wire clamp grooves 1101 on a circuit board 110 by wire bonding. The exterior of the patch panel 10 has a plurality of jack plugs (not shown in the figure) for users to insert a network cable into one of the jack plugs (not shown in the figure), so as to form an interconnect network communication circuit. However, it is necessary to replace the whole circuit board 110 in the traditional patch panel 10, if any one of the plurality of wire clamp grooves 1101 on the circuit board 110 fails, and thus causing an increase of cost. Since the plurality of wire clamp grooves 1101 are densely located, there will be an issue of signal interference if every wire clamp groove 1101 is hooked up with a network cable. In view of the foregoing shortcomings, it demands immediate attentions for finding a way of developing a patch panel 10, such that if a certain wire clamp groove 1101 fails, it is not necessary to replace the whole circuit board 110, and the signal interference between the network circuits can be reduced.

### SUMMARY OF THE INVENTION

Therefore, it is a primary objective of the present invention to provide a high density module connector to substitute a circuit board of a traditional patch panel and improve the shortcoming of replacing the whole circuit board when a certain wire clamp groove on the circuit board fails. If a connector in the high density module connector fails, users only need to change the connector, so that the patch panel can be operated normally again. The high density module connector can effectively separate the circuits and reduce the interference caused by the densely installed circuits.

The module connector comprises a combining base, a plurality of connectors and a packaging module. This panel includes a plurality of through holes and a plurality of grooves disposed on both sides of the panel. The combining base includes a plurality of separating bars for separating each connector, and thus the connectors can be arranged orderly. The combining base also includes a plurality of first latches and a plurality of second latches, and the first latches are coupled to a groove of the panel, and the plurality of second latches are coupled to the patch panel. The patch panel comprises a first through hole for mounting the high density module connector, a second through hole coupled to the corresponding second latch of the packaging module, and a third through hole for fixing the patch panel to a server box by a plurality of screws.

The above and other objects, features and advantages of the present invention will become apparent from the following detailed description taken with the accompanying drawing.

### BRIEF DESCRIPTION OF THE DRAWINGS

FIG. 1 is a perspective view of a traditional wire-bonded patch panel;

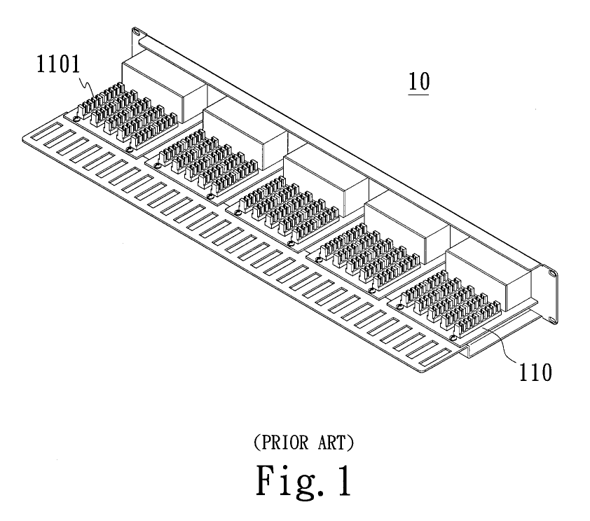

FIG. 2 is a perspective view of a high density module connector of the present invention;

FIG. 3 is a perspective view of a high density module connector connected to a patch panel according to the present invention;

FIG. 4 is a perspective view of the assembly of a high density module connector and the patch panel according to the present invention; and

FIG. 5 is a perspective view of another preferred embodiment of the present invention.

### DETAILED DESCRIPTION OF THE PREFERRED EMBODIMENTS

The above and other technical characteristics and advantages of the present invention will become apparent from the following detailed taken with the accompanying drawings.

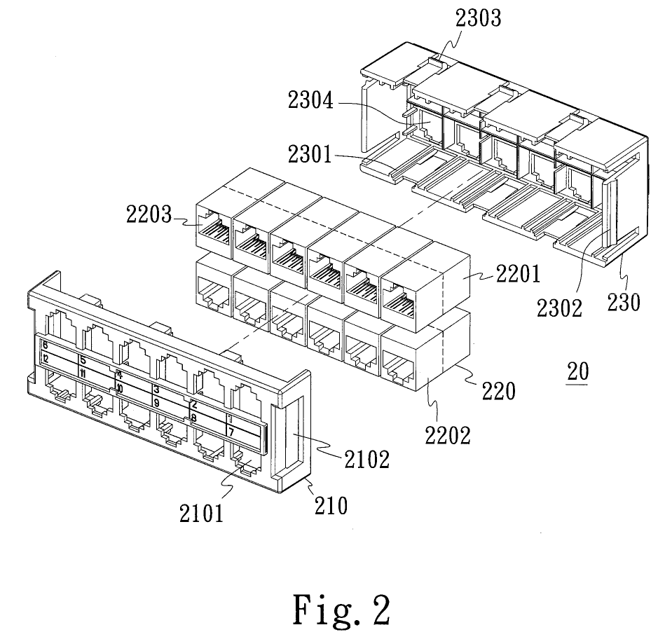

Referring to FIG. 2 for a perspective view of a high density module connector according to a first preferred embodiment of the present invention; the high density module connector 20 comprises a combining base 210, a plurality of connectors 220 and a packaging module 230. The combining base 210 comprises: a plurality of through holes 2101; a plurality of grooves 2102 disposed on both sides of the combining base 210, and each connector 220 can be divided into a first casing 2201 and a second casing 2202 separately coupled separately to a network cable, and the jack plug 2203 of the second casing 2202 corresponds the through hole 2101 on the combining base 210, such that the network cable can be passed through the through hole 2101 of the combining base 210 and connected to the connector 220. The packaging module 230 has a plurality of separating bars 2301 disposed at upper and lower surfaces of the packaging module 230 for separating each connector 220, such that the plurality of connector 220 can be arranged orderly and will not shaken sideway. A plurality of first latches 2302 are disposed on both left and right sides of the packaging module 230 and coupled to corresponding grooves 2102 of the panel 210 for fixing a plurality of connectors 220 tightly between the panel 210 and the packaging module 230. A plurality of second latches 2303 are disposed on both upper and lower ends of the external side of the packaging module 230 and coupled to a patch panel (not shown in the figure). Similarly, another side of the packaging module 230 has a plurality of through holes 2304, and each through hole 2304 corresponds to a jack plug (not shown in the figure) of the first casing 2201 of the connector 220, such that the network cable can be passed through the through hole 2304 of the packaging module 230 and connected with the connector 220, and finally connected to the combining base 210, the plurality of connectors 220 and the packaging module 230 to constitute a complete high density module connector 20.

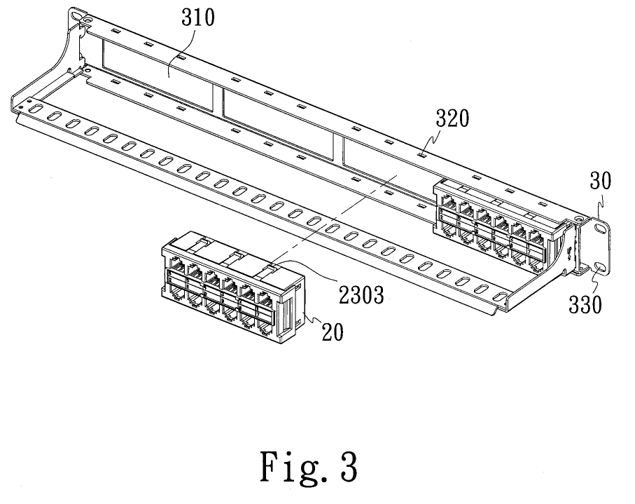

Referring to FIG. 3 for the connection of a high density module connector with a patch panel according to the present invention, a lateral surface of the patch panel 30 has a plurality of first through holes 310 for mounting a plurality of high density module connectors 20 thereon, and the top and bottom of the patch panel 30 respectively correspond to a plurality of second through holes 320 coupled to a plurality of second latches 2303 of the high density module connector 20 for preventing the high density module connector 20 from falling out. Both left and right ends of the patch panel 30 separately include a plurality of third through holes 330, and a plurality of screws (not shown in the figure) are passed through the third through holes 330 of the patch panel 30 for fixing the patch panel 30 in a server box (not shown in the figure).

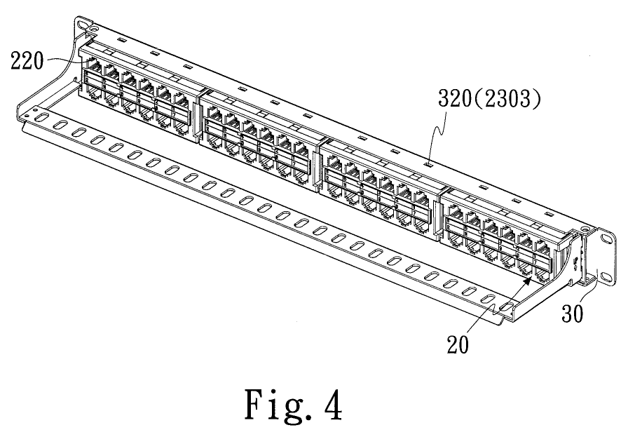

Referring to FIG. 4 for a schematic view of the assembly of a high density module connector and a patch module according to the present invention together with FIGS. 2, and 3, the patch panel 30 has four first through holes (not shown in FIG. 4) for mounting four high density module connectors 20 respectively, and each high density module connector 20 has twelve connectors 220, and thus the patch panel 30 can connect 48 pieces of network cables, and each network cable is separated by the connector 20 of the high density module to reduce the interference of the communication signals. If a certain connector 220 of the patch panel 30 fails, it is necessary to remove the high density module connector 20 at the failed connector 220 and replace the failed connector 220, and then reinstall the high density module connector 20 and mount the high density module connector 20 into the patch panel 30, so that the patch panel 30 can be operated normally again. However, the quantity of components used in this embodiment is given as an example for the illustration and not intended to limit the present invention. The patch panel 30 of the invention also can use four ports to connect four pieces of network cables, or eight ports to connect eight pieces of network cables, and so on. Further, the connector could be a network connector.

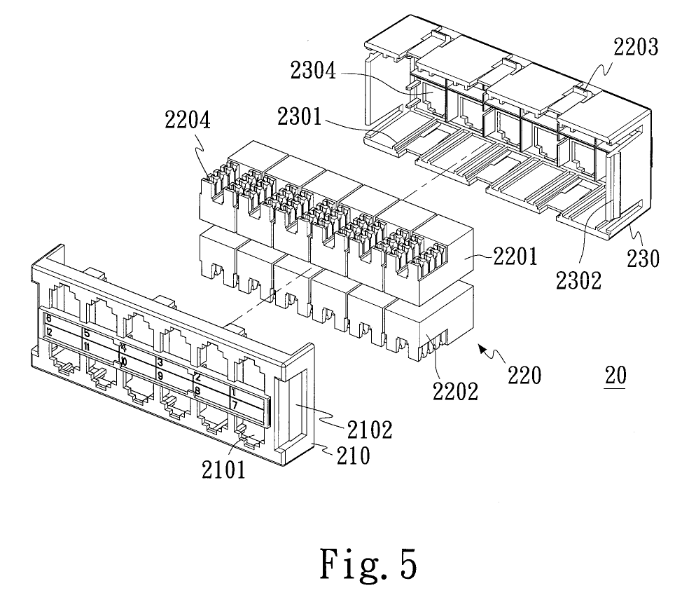

Referring to FIG. 5 for a perspective view of another preferred embodiment of the present invention, the high density module connector 20 comprises a combining base 210, a plurality of connectors 220 and a packaging module 230. The combining base 210 has a plurality of through holes 2101, and both left and right sides of the panel have a plurality of grooves 2102. Each connector 220 can be divided into a first casing 2201 and a second casing 2202 separately coupled with the network cable. Unlike the first preferred embodiment, the first casing 2201 of the plurality of network connectors has a jack plug (not shown in the figure), and a penetrating base 2204 disposed at the second casing 2202, such that the network cable can be coupled to the connector 220 by wire bonding. Further, the plurality of connectors 220 respectively correspond to a plurality of through holes 2101 on the panel 210 thereon, such that the network cable can be passed through the through hole 2101 of the combining base 210 and connected to the connector 220. The upper and lower surface in the packaging module have a plurality of separating bars 2301, and thus the plurality of connectors 220 can be arranged orderly and will not shaken sideway. The left and right sides of the packaging module 230 have a plurality of first latches, and a groove of the packaging module corresponds to a latch of the panel for fixing the plurality of network connectors therein. Both left and right sides of the packaging module 230 have a plurality of first latches 2302 coupled to the corresponding grooves 2102 of the panel 210 for fixing the plurality of connectors 220 tightly between the combining base 210 and the packaging module 230, and a plurality of second latches 2303 are installed on both upper and lower ends of the packaging module 230 for connecting the patch panel (not shown in the figure). Similarly, a plurality of through holes 2304 are disposed on another side of the packaging module 230, and each through hole 2304 corresponds to a jack plug (not shown in the figure) of the first casing 2201 of the connector 220, such that the network cable can be passed through the through hole 2304 of the packaging module 230 and connected to the connector 220 and finally coupled to the combining base 210, the plurality of connectors 220 and the packaging module 230 to form a complete high density module connector 20.

In summation of the description above, the improved windshield wiper structure of the present invention effectively overcomes the shortcomings of the prior art, enhances the performance over the conventional structure and complies with the patent application requirements.

What is claimed is:

1. A high density module connector, comprising:
a combining base, including a plurality of through holes and a plurality of grooves disposed on both sides of said combining base;
a plurality of connectors, including a first casing and a second casing; and
a packaging module, including a plurality of separating bars for separating said each connector, such that said connector can be arranged orderly, a plurality of first latches coupled to corresponding combining base grooves respectively, and a plurality of second latches for connecting a patch panel.

2. The high density module connector of claim 1, wherein said patch panel comprises a first through hole, a second through hole and a third through hole.

3. The high density module connector of claim 2, wherein said first through hole of said patch panel is used for mounting said high density module connector.

4. The high density module connector of claim 2, wherein said second through hole of said patch panel is used for installing said second latch of said high density module connector.

5. The high density module connector of claim 2, wherein said third through hole of said patch panel is used for fixing said patch panel to a server box by a plurality of screws.

6. The high density module connector of claim 1, wherein said first casing of said connectors comprises a groove coupled to a corresponding through hole of said packaging module.

7. The high density module connector of claim 1, wherein said second casing of said connectors comprises a groove coupled to a corresponding through hole of said combining base.

8. The high density module connector of claim 1, wherein said second casing of said connectors comprises a penetrating distal base coupled to a corresponding through hole of said combining base and coupled to a network cable by wire bonding.

9. The high density module connector of claim 1, wherein said connector is an Ethernet connector.
